(19) United States
(12) Patent Application Publication
(10) Pub. No.: US 2026/0346661 A1
(43) Pub. Date: Nov. 5, 2026

(54) Trailer Coupler, a Method of Use and a Vehicle

(71) Applicant: Global Manufacturing Holdings LLC, Lisle, IL (US)

(72) Inventor: Zhengyi Jiao, Warrenville, IL (US)

(21) Appl. No.: 19/425,997

(22) Filed: Dec. 18, 2025

Related U.S. Application Data
(60) Provisional application No. 63/736,198, filed on Dec. 19, 2024.

(51) Int. Cl. B60D 1/06

(52) U.S. Cl. CPC B60D 1/065

(57) ABSTRACT

A coupling includes a ball socket, a lever, a connecting rod, a spring, a locking block and a locking pin. A cavity is provided in the ball socket, the locking block is rotatably connected in the cavity, the first end of the connecting rod is connected to the locking block, the second end passes through the ball socket and is rotatably connected to the lever located outside the ball socket, the spring is sleeved on the outside of the connecting rod and abuts between the connecting rod and the ball socket. a first cavity for accommodating a hitch ball is formed between the first side of the locking block and the inner wall of the ball socket, the second side of the locking block has a first concave, and a second concave is provided at the inner wall of the ball socket; when the lever is closed, the first concave and the second concave form a second cavity for accommodating the locking pin, and the lower opening size of the first cavity is smaller than the projection size of the hitch ball at the lower opening of the first cavity.

This application claims the benefit of U.S. Ser. No. 63/736,198 filed Dec. 19, 2024.

### TECHNICAL FIELD

The present disclosure relates to the technical field of trailer couplers, and in particular to a trailer coupler, a method of use, and a vehicle.

### BACKGROUND

The trailer coupler is a structure that connects the tow vehicle and the trailer. For example, for a towable RV, the trailer coupler is an important structure that connects the tow vehicle and the towable RV. Usually, a hitch ball is set at the rear of the tow vehicle, and the trailer coupler is installed at the front of the trailer. The trailer coupler and the hitch ball are matched and connected to achieve the connection between the tow vehicle and the trailer.

However, the present inventor recognizes that the trailer couplers in the prior art are inconvenient to disassemble and assemble, and it is difficult to disassemble and assemble with one hand. The present inventor recognizes it would be desirable to provide a trailer coupler that was more convenient to disassemble and assemble while providing a secure coupling between a trailer and a tow vehicle.

### SUMMARY

The disclosed embodiment provides a trailer coupler, a method of use and a tow vehicle to decrease difficulty in disconnection and connection of trailer coupler in the prior art while having sufficient connection strength.

In the first aspect, A trailer coupler is provided having a first housing and a ball socket for receiving a ball, the ball socket connected to or formed with the first housing. The ball socket has variable sizes for receiving and locking-in a ball within the socket. A locking block is rotatably mounted to the first housing and is movable to enlarge or constrict the entry size upon rotation. A lever is located outside of the first housing. A connecting rod is rotationally connected to the lever outside the first housing and penetrates the first housing. The connecting rod is rotationally connected to the locking block within the first housing, wherein rotation of the lever translates the connecting rod and translation of the connecting rod rotates the locking block to either allow or restrict movement of the ball within the ball socket.

In another aspect, the trailer coupler is provided, including the ball socket, the lever, the connecting rod, a spring, the locking block and a locking pin. A first cavity is provided in the ball socket, and the locking block is exposed into the cavity. A first end of the connecting rod is connected to the locking block, and the second end passes through the first housing and is rotatably connected to the lever located outside the first housing. The spring is sleeved on the outside of the connecting rod and abuts between the connecting rod and the first housing. The first cavity accommodates a hitch ball and is nested between a first side of the locking block and an inner wall of the ball socket. A second side of the locking block has a first concave, and a second concave is provided on the inner wall of the first housing. When the lever is closed, the first concave and the second concave form a second cavity for accommodating the locking pin, and the lower opening size of the first cavity is smaller than the projection size of the hitch ball at the lower opening of the first cavity.

In a possible implementation, the first concave of the locking block has a first convex at the lower part, and when the lever is closed, the first concave, the first convex, and the second concave together form a second cavity for accommodating the locking pin.

In a possible implementation, when the lever is opened, the locking block rotates under the drive of the lever, and the first convex enters the second concave, thereby expanding the first cavity.

In a possible implementation, the lever has a second convex at one end close to the rotation connection position with the connecting rod, which is used to make the connecting rod move axially away from the locking block when the lever is opened.

In a possible implementation, when the locking pin is inserted into the second cavity, the area of the locking pin wrapped by the first concave and the first convex is larger than the area of the locking pin wrapped by the second concave.

In a possible implementation, the outer periphery of the connecting rod has a third convex, and the spring is compressed and arranged between the inner wall of the first housing and the third convex.

In a possible implementation, a second housing is also included, the second housing is fixedly connected to, or formed with, the first housing which is connected to the ball socket, and the second housing is located on the side away from the ball socket away from the first cavity. The second housing can be fashioned to be a connecting plate for connecting the trailer coupler to a tow vehicle or to a trailer, depending on which one has the ball, and which one has the trailer coupler.

In a possible implementation, the locking pin is connected to the first or second housing via a connecting tether.

In the second aspect, based on a trailer coupler described above, a method of use for the trailer coupler includes the steps of:
pulling out the locking pin;
opening the lever, so that the lever drives the connecting rod to move upward, thereby driving the locking block to rotate, so that the space of the first cavity formed between the locking block and the inner wall of the ball socket increases;
disconnecting the hitch ball from the first cavity to complete the removal of the hitch ball;
closing the lever and inserting the locking pin.

In the third aspect, a vehicle is provided, comprising a tow vehicle and a trailer, wherein the tow vehicle has a power system and the trailer does not have a power system. The rear of the tow vehicle has a vertically oriented hitch ball, and the front of the trailer has a trailer coupler as described above, which is used to connect with the hitch ball to achieve the connection between the trailer and the tow vehicle.

Alternately, the front of the trailer has the vertically oriented hitch ball, and the rear of the tow vehicle has a trailer coupler as described above, which is used to connect with the hitch ball to achieve the connection between the trailer and the tow vehicle.

The exemplary embodiment provides a trailer coupling, a method of use and a vehicle, which realizes a tight connection of the hitch ball by using a ball socket, a locking block and a locking pin. The locking block is designed to be rotatable and can rotate to change the size of the first cavity under the drive of the lever, thereby loosening or locking the hitch ball in the first cavity. The locking pin is used in conjunction with the lever to achieve a double secure connection.

Advantages of additional aspects of the present disclosure will be given in part in the following description and in part will become apparent from the following description, or will be learned through practice of the present disclosure.

### BRIEF DESCRIPTION OF THE DRAWINGS

To further illustrate the technical solutions in the present disclosed embodiment, the drawings required for use in the description of the embodiment will be briefly introduced below. Obviously, the drawings described below are only some of the present disclosed embodiments. For ordinary technicians in this field, other drawings can be obtained based on these drawings without paying any creative work.

FIG. 1 is a schematic perspective view of the overall structure of a trailer coupler of the present disclosed embodiment;

FIG. 2 is a cross-sectional view of the trailer coupler of FIG. 1, taken through plane 2-2 of FIG. 1 in a closed state;

FIG. 3 is a cross-sectional view of the trailer coupler of FIG. 1, taken through plane 2-2 of FIG. 1, but in an open state;

FIG. 4 is a schematic perspective view of the ball socket structure taken from FIG. 3 in an open state;

FIG. 5 is a schematic perspective view of the ball socket structure taken from FIG. 2 in a closed;

FIG. 6 is a cross-sectional view of the ball socket structure taken through the plane 6-6 of FIG. 5 in a closed state.

### DETAILED DESCRIPTION

In order to make the objectives, technical solutions and advantages of the present disclosure clearer, the present disclosed embodiment will be further described in detail below with reference to the accompanying drawings.

The terms “first”, “second”, etc. in the specification, claims and drawings of the present disclosure are used to distinguish different objects, rather than to describe a specific order. The description of positions such as “upper” and “lower” is based on the relative positions of the structures shown in the drawings and the devices in daily working conditions. It is only for the convenience of describing the relative positional relationship between the structures and does not represent a limitation on the structure itself. In addition, the terms “include” and “have”, and any variations thereof, are intended to cover non-exclusive inclusions. For example, processes, methods, systems, products or devices that include a series of steps or units are not limited to the listed steps or units, but optionally include steps or units that are not listed, or optionally include other steps or units that are inherent to these processes, methods, products or devices.

This application incorporates by reference U.S. Ser. No. 63/736,198 filed Dec. 19, 2024, in its entirety.

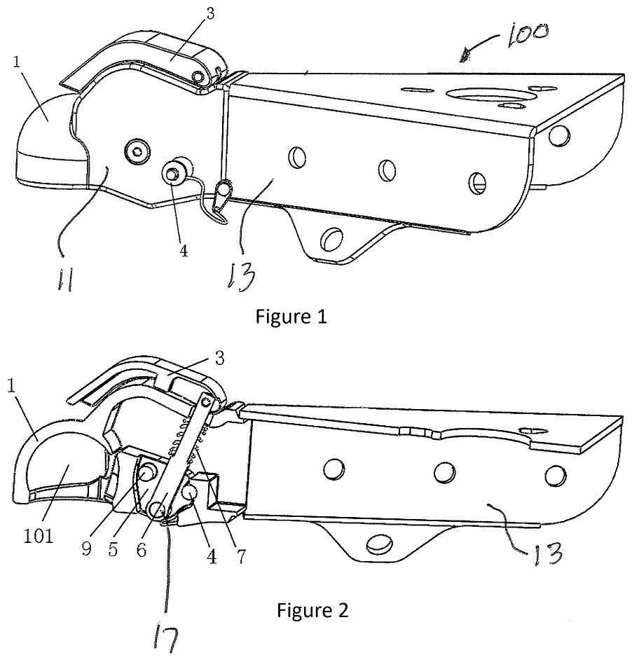

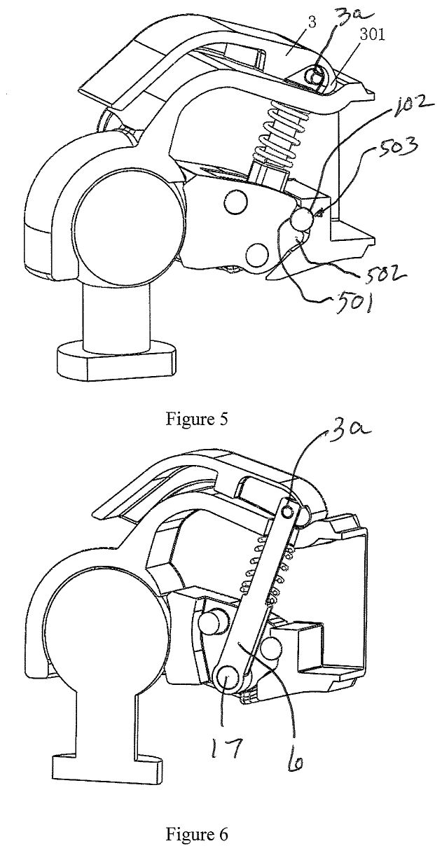

The present disclosed embodiment provides a trailer coupler 100, referring to FIGS. 1 to 6, which includes a ball socket 1, which is connected to, or formed with, a first housing 11, which is connected to, or formed with, a second housing 13. A lever 3, a connecting rod 6, a spring 7, a locking block 5, and a locking pin 4 are provided. A first cavity 101 is provided in the ball socket 1, and the locking block 5 is rotatably connected to the first housing 11 and exposed into the first cavity. A first end of the connecting rod 6 is rotatably connected to the locking block 5, and the second end passes through the first housing 11 and is rotatably connected to the lever 3 outside the first housing 11. The spring 7 is sleeved on the outside of the connecting rod 6 and abuts between the connecting rod 6 and the first housing 11. A first cavity 101 for accommodating a hitch ball 8 is formed between a first side of the locking block 5 and the inner wall of the ball socket 1.

The second side of the locking block 5 has a first concave 501, and a second concave 102 is provided by the first housing 11. When the lever is closed, the first concave 501 and the second concave 102 form a second cavity 503 for accommodating the locking pin 4, so as to facilitate the insertion of the locking pin 4 to achieve locking, and the lower opening size of the first cavity is smaller than the projection size of the hitch ball at the lower opening of the first cavity, so as to limit the hitch ball and prevent the hitch ball from disengaging.

The trailer coupler provided in the present disclosed embodiment is used in conjunction with a hitch ball to connect a tow vehicle and a trailer together. For the convenience of description, the following description assumes that the hitch ball is arranged on the tow vehicle with driving power and the trailer coupler is arranged on the trailer. The trailer coupler can connect the tow vehicle and the trailer, and keep the trailer in a suitable position at all times during operation, playing the role of towing, buffering, and connecting. The head of the trailer coupler has a first cavity for accommodating the hitch ball. After the lever is opened, the locking block rotates to make room and expands the first cavity to facilitate the hitch ball to enter the first cavity. When the lever is closed, the locking block is close to the hitch ball to limit the hitch ball and prevent the hitch ball from disengaging. In addition, the locking pin can also provide double protection after the lever is closed, further enhancing the connection strength, so that the coupler ball socket can withstand higher intensity impacts. The lever is easy to open manually and easy to operate.

The first concave 501 of the locking block 5 is contiguous with a first convex 502 at the lower part thereof. When the lever 3 is closed by downward rotation, the first concave 501, the first convex 502, and the second concave 102 together form a second cavity for accommodating the locking pin 4.

The locking block 5 is rotatably connected in the first housing 11 through a pin shaft 9 and can rotate about the pin shaft 9. The connecting rod 6 is rotationally connected to the locking block 5 by a bolt 17. The first housing 11 is provided with a through hole 11a at an upper position where the connecting rod 6 passes through the first housing, and the diameter of the through hole 11a should meet the requirements of the movement range of the connecting rod during the lever opening and closing to avoid interference. The lever 3 is rotatably connected by a pin 3a to the connecting rod 6, and the end of the lever 3 close to the pin 3 has a cam or second convex 301, so that when the lever 3 is opened, the connecting rod 6 can move toward the outside of the first housing 11 under the cam action of the second convex 301 against the first housing 11, which drives the locking block 5 to rotate along the pin shaft 9. At this time, the first convex 502 of the locking block enters the second concave 102, thereby expanding the first cavity 101, so that the hitch ball can move in or out of the lower part of the first cavity 101.

A diameter of the connecting rod 6 close to the locking block expands to form a third convex 6a, and the spring 7 is sleeved on the outside of the connecting rod 6, with one end abutting against the upper, inner wall of the first housing 11 and the other end abutting against the third convex 6a. The spring 7 is a compression spring, so that it can continuously provide the connecting rod 6 with a thrust in the direction of the locking block, so as to ensure the structural strength and facilitate the closing of the lever 3. When the lever 3 is closed, the connecting rod 6 retracts downward into the first housing 11 under the drive of the spring 7, thereby driving the locking block 5 to rotate along the pin shaft 9, the first convex 502 escapes downward from the second concave 102, and the lower space of the first cavity 101 is reduced to a diameter smaller than the hitch ball, thereby limiting the movement of the hitch ball preventing trailer disconnection. At the same time, after the lever is closed, the first concave 501, the first convex 502, and the second concave 102 together form a second cavity 503 for accommodating a locking pin 4, and then the locking pin 4 is inserted into the second cavity 503 to further complete the locking of the overall structure. In addition, considering the spring life, locking quality and connection strength of the connecting rod in the long-term use of the structure, the trailer coupler is designed to be operated by manually opening and closing the lever 3, rather than the structure in which the hitch ball is automatically lifted and locked, thereby enhancing the safety and reliability of the device.

In a possible implementation, when the locking pin is inserted into the second cavity 503, the area of the locking pin wrapped by the first concave 501 and the first convex 502 is larger than the area of the locking pin wrapped by the second concave 102. According to FEA, the stress at the first convex 502 is relatively large. Therefore, in order to reduce stress concentration and increase structural strength, the structure of the first convex is specially designed in combination with the simulation results, so that the first convex exceeds the range of the lower part of the locking pin, and the first concave and the first convex of the locking block as a whole wrap the range of the locking pin, which is larger than more than half of the locking pin. At the same time, this structure can also ensure that when the first convex 502 rotates, it can enter the second concave 102 and will not collide with other structures, thereby improving the compatibility between the various structures.

To facilitate the connection between the tow vehicle and the trailer, a second housing 13 is also fixedly connected to, or formed with, the ball socket 1. The second housing 13 is fixedly connected to, or formed with, the first housing 11 on a side opposite the ball socket 1. The second housing includes fastener holes for mounting to either a tow vehicle or to a trailer depending on which one has the ball and which one has the ball socket.

The position of the first cavity is taken as the head of the ball socket, and the side away from the position of the first cavity is taken as the tail. The ball socket is connected to the hitch ball of the tow vehicle through the head and connected to the coupler seat to the tail side, so as to facilitate the connection with the trailer.

In a possible implementation, a connecting tether, such as a chain or cable, is provided on the outer side of the first or second housings, one end of the connecting tether is connected to the first or second housing, and the other end is connected to the locking pin to prevent the locking pin from being lost.

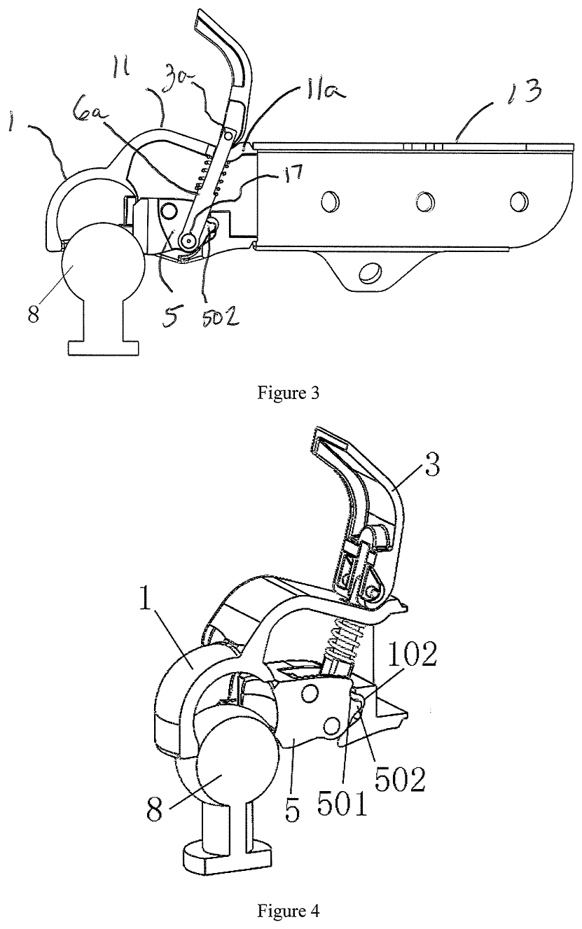

Based on the trailer coupler 100 described above, the present disclosed embodiment further provides a method of use for the trailer coupler, including a method for disengaging a hitch ball, specifically comprising the steps of:
pulling out the locking pin;
opening the lever by rotation (clockwise in FIG. 3), so that the lever drives the connecting rod to move upward, and then drives the locking block to rotate (counterclockwise in FIG. 3), so that the space of the first cavity formed between the locking block and the inner wall of the ball socket increases;
disengaging the hitch ball from the first cavity;
closing the lever by rotation (counterclockwise in FIG. 3) and inserting the locking pin to secure the locking pin for future use.

The method for engaging the hitch ball is similar, including the steps of:
pulling out the locking pin;
opening the lever by rotation (clockwise in FIG. 3), so that the lever drives the connecting rod to move upward, and then drives the locking block to rotate (counterclockwise in FIG. 3), so that the space of the first cavity formed between the locking block and the inner wall of the ball socket increases;
inserting the hitch ball from the lower part of the first cavity into the first cavity;
closing the lever by rotation (counterclockwise in FIG. 3);
inserting the locking pin, so that the hitch ball rests on the arc structure of the inner wall of the ball socket and is firmly connected with the ball socket.

The present disclosed embodiment also provides a vehicle, including a tow vehicle and a trailer, wherein the tow vehicle has a power system and the trailer does not have a power system. The rear of the tow vehicle has a vertically oriented hitch ball, and the front of the trailer has a trailer coupler as described herein, which is used to connect with the hitch ball to achieve the connection between the trailer and the tow vehicle. Alternately, the front of the trailer has a vertically oriented hitch ball, and the rear of the tow vehicle has a trailer coupler as described herein, which is used to connect with the hitch ball to achieve the connection between the trailer and the tow vehicle.

The above description is only an exemplary embodiment and is not intended to limit the present disclosure. For those skilled in the art, the present disclosure may have various modifications and changes. Any modifications, equivalent substitutions, improvements, etc. made within the spirit and principles of the present disclosure shall be included in the protection scope of the present disclosure.

1. A trailer coupler, comprising:
a first housing;
a ball socket for receiving a ball, the ball socket having a selectable entry size for receiving and locking in a ball within the socket, the ball socket connected to or formed with the first housing;
a locking block that is rotatably mounted to the first housing to enlarge or constrict the entry size upon rotation;
a lever located outside of the first housing;
a connecting rod rotationally connected to the lever outside the first housing and penetrating the first housing, the connecting rod rotationally connected to the locking block within the first housing, wherein rotation of the lever translates the connecting rod, and translation of the connecting rod rotates the locking block to either allow or restrict movement of the ball within the ball socket.

2. The trailer coupler according to claim 1, further comprising a second housing, fixed to, or formed with the first housing on a side opposite the ball socket, the second housing fashioned to connect the trailer coupler to a tow vehicle or trailer.

3. A trailer coupler, characterized in that it includes a ball socket, a lever, a connecting rod, a spring, a locking block, and a locking pin; a cavity is defined in the ball socket, the locking block is rotatably connected in the cavity, a first end of the connecting rod is connected to the locking block, a second end passes through the ball socket and is rotatably connected to the lever located outside the ball socket, the spring is sleeved on the outside of the connecting rod and abuts between the connecting rod and the ball socket, a first cavity for accommodating a hitch ball is formed between a first side of the locking block and an inner wall of the ball socket, a first concave is provided on a second side of the locking block, and a second concave is defined on the inner wall of the ball socket; when the lever is closed, the first concave and the second concave form a second cavity for accommodating the locking pin, and the lower opening size of the first cavity is smaller than the projection size of the hitch ball at the lower opening of the first cavity.

4. A trailer coupler as claimed in claim 3, characterized in that the lower part of the first concave of the locking block has a first convex, and when the lever is closed, the first concave, the first convex, and the second concave together form a second cavity for accommodating the locking pin.

5. A trailer coupler as claimed in claim 4, characterized in that when the lever is opened, the locking block rotates driven by the lever, and the first convex enters the second concave, thereby expanding the first cavity.

6. A trailer coupler as claimed in claim 4, characterized in that the lever has a second convex at one end close to the rotational connection position with the connecting rod, which is used to make the connecting rod move axially in a direction away from the locking block when the lever is opened.

7. A trailer coupler as claimed in claim 4, characterized in that when the locking pin is inserted into the second cavity, an area of the locking pin wrapped by the first concave and the first convex is larger than an area of the locking pin wrapped by the second concave.

8. A trailer coupler as claimed in claim 3, characterized in that the outer periphery of the connecting rod has a third convex, and the spring is compressed and arranged between the inner wall of the ball socket and the third convex.

9. A trailer coupler as claimed in claim 3, characterized by further comprising a coupler seat, wherein the coupler seat is fixedly connected to the ball socket, and the coupler seat is located on a side away from the ball socket and away from the first cavity.

10. A trailer coupler as claimed in claim 9, characterized in that the locking pin is tethered to the coupler seat.

11. (canceled)

12. (canceled)

13. (canceled)
